(19) United States
(12) Patent Application Publication
(10) Pub. No.: US 2025/0122633 A1
(43) Pub. Date: Apr. 17, 2025

(54) SIX-MEMBERED HIGH-ENTROPY FOAMS FOR HYDROGEN PRODUCTION BY WATER SPLITTING AND PREPARATION METHODS THEREOF

(71) Applicant: SOUTHEAST UNIVERSITY, Nanjing (CN)

(72) Inventors: Xuhai ZHANG, Nanjing (CN); Tongheng WANG, Nanjing (CN); Yuqiao ZENG, Nanjing (CN); Peng CUI, Nanjing (CN); Chongyang BA, Nanjing (CN); Feng FANG, Nanjing (CN); Qiyue SHAO, Nanjing (CN); Haoran ZHENG, Nanjing (CN); Pengcheng ZHAO, Nanjing (CN); Jianqing JIANG, Nanjing (CN)

(73) Assignee: SOUTHEAST UNIVERSITY, Nanjing (CN)

(21) Appl. No.: 18/940,787

(22) Filed: Nov. 7, 2024

Related U.S. Application Data
(63) Continuation of application No. PCT/CN2022/139925, filed on Dec. 19, 2022.

(30) Foreign Application Priority Data
May 7, 2022 (CN) 202210490535.6

(51) Int. Cl. C25B 11/089; C22C 30/02; C25B 11/031; C25D 3/56; C25D 5/00; C25D 5/48

(52) U.S. Cl. CPC C25B 11/089; C22C 30/02; C25B 11/031; C25D 3/56; C25D 5/48; C25D 5/623

(57) ABSTRACT

Six-membered high-entropy foam for hydrogen production by water splitting and preparation method are provided. The foam consists of Ni, Fe, Cu, Co, Mo, and Pt, comprising 10 at %-25 at % of Ni, 10 at %-25 at % of Fe, 10 at %-25 at % of Cu, 10 at %-25 at % of Co, 10 at %-25 at % of Mo, and 10 at %-25 at % of Pt. Catalyst loading of the foam can reach a range of 0.8 mg/cm²-3.2 mg/cm², which is much higher than the effective catalyst loading of most nano-catalysts. When used as catalyst for hydrogen production by water splitting, the hydrogen evolution overpotential of the surface of the six-membered high-entropy foam is within a range of 36 mV-60 mV, and the foam operates stably at industrial-level current density (500 mA/cm²). The preparation method does not require harsh environment such as high temperature or high vacuum, making the method simple and easy to implement, with low-cost raw materials.

### CROSS REFERENCE TO RELATED APPLICATIONS

The present application is a continuation of International Application No. PCT/CN2022/139925, filed on Dec. 19, 2022, which claims priority to Chinese Patent Application No. 202210490535.6, filed on May 7, 2022, the entire contents of each of which are incorporated herein by reference.

### TECHNICAL FIELD

The present disclosure belongs to the technical field of preparation of micro-nano materials and relates to a six-membered high-entropy foam for hydrogen production by water splitting and a preparation method thereof, and in particular, to a six-membered high-entropy foam for hydrogen production by water splitting with high activity and high stability and a preparation method thereof.

### BACKGROUND

In existing technologies, hydrogen energy is one of the cleanest renewable energy sources. Among numerous clean energy sources, hydrogen energy is undoubtedly the most promising energy in replacing fossil fuels in the future, thereby establishing a new green energy system with hydrogen as the carrier.

There are many ways to obtain hydrogen energy, among which water electrolysis technology, driven by renewable energy, is an environmentally friendly technique for producing high-purity hydrogen. However, due to the high overpotential required for the hydrogen evolution reaction, catalysts must be used on the electrode materials. Pt-based materials have the most suitable hydrogen adsorption free energy (close to 0), which contributes to excellent hydrogen evolution reaction (HER) catalytic performance. However, Pt-based catalysts are not only expensive and have scarce reserves but also have poor catalytic stability in HER.

In recent years, new alloy materials have been developed by combining precious metals with non-precious metals through alloying manners, aiming to reduce the usage amount of precious metals while maintaining their excellent catalytic activity and improving catalytic stability. However, most of these materials face several issues, including complex preparation processes, low effective catalyst loading, and the need for improvements in catalytic performance.

### SUMMARY

In order to solve the above problems, the present disclosure provides a six-membered high-entropy foam for hydrogen production by water splitting with high activity and high stability, the foam has good catalytic activity, which may be used in efficient and stable hydrogen production by water splitting technology. The present disclosure also provides a method for preparing a six-membered high-entropy foam for hydrogen production by water splitting with high activity and high stability, which is simple, and the NiFeCuCoMoPt high-entropy alloy prepared using the method has both nanoparticles and hierarchical porous structure.

The present disclosure may provide a six-membered high-entropy foam for hydrogen production by water splitting, comprising 10 at %-25 at % of Ni, 10 at %-25 at % of Fe, 10 at %-25 at % of Cu, 10 at %-25 at % of Co, 10 at %-25 at % of Mo, and 10 at %-25 at % of Pt.

In some embodiments, the six-membered high-entropy foam may have 3D-connected micron-scale pores.

In some embodiments, diameters of the micron-scale pores may be within a range of 0.2 um-25 um; and walls of the micron-scale pores may be composed of NiFeCuCoMoPt particles packing.

In some embodiments, sizes of the NiFeCuCoMoPt particles may be within a range of 100 nm-300 nm.

In some embodiments, catalyst loading of the six-membered high-entropy foam may be within a range of 0.8 mg/cm²-3.2 mg/cm², and a hydrogen evolution overpotential of a surface of the six-membered high-entropy foam after cleaning and activation may be within a range of 36 mV-60 mV.

The present disclosure may also provide a method for preparing a six-membered high-entropy foam for hydrogen production by water splitting, comprising:
operation (1), obtaining a colorless and transparent solution by dissolving complexes (NH₄)₂SO₄, Na₃C₆H₅O₇, and H₃BO₃ in ultrapure water under stirring;
operation (2), obtaining a mixed solution by dissolving metal salts NiSO₄, Fe₂(SO₄)₃, CuSO₄, CoSO₄, Na₂MoO₄, and K₂PtCl₄ in the colorless and transparent solution in sequence under stirring;
operation (3), obtaining a six-membered high-entropy foam by using a Ni sheet as a working electrode and a Pt sheet as a counter electrode, controlling a temperature to 25° C., and performing constant current electrodeposition on the mixed solution;
operation (4), after the constant current electrodeposition is completed, obtaining a washed six-membered high-entropy foam by immersing the six-membered high-entropy foam in the ultrapure water to remove residual impurities on a surface of the six-membered high-entropy foam and washing for three times; and
operation (5), obtaining the six-membered (NiFeCuCoMoPt) high-entropy foam by placing the washed six-membered high-entropy foam in a freeze dryer and freeze-drying for 4 h.

In some embodiments, in operation (1), in the colorless and transparent solution, a concentration of (NH₄)₂SO₄ may be within a range of 0.4 M-0.6 M, a concentration of Na₃C₆H₅O₇ may be within a range of 0.2 M-0.4 M, and a concentration of H₃BO₃ may be within a range of 0.3 M-0.5 M.

In some embodiments, in operation (2), in the mixed solution, a concentration of NiSO₄ may be within a range of 0.002 M-0.006 M, a concentration of Fe₂(SO₄)₃ may be within a range of 0.001 M-0.002 M, a concentration of CuSO₄ may be within a range of 0.0002 M-0.0006 M, a concentration of CoSO₄ may be within a range of 0.001 M-0.003 M, a concentration of Na₂MoO₄ may be within a range of 0.002 M-0.008 M, and a concentration of K₂PtCl₄ may be within a range of 0.002 M-0.008 M.

In some embodiments, in operation (3), a current density of the constant current electrodeposition may be within a range of 1 A/cm²-4 A/cm², and a deposition time may be within a range of 90 s-360 s.

In some embodiments, in operation (4), an immersion time of the six-membered high-entropy foam in the ultrapure water may be 15 min.

The beneficial effect of the present disclosure is as follows: the six-membered high-entropy foam for hydrogen production by water splitting with high activity and high stability has the catalyst loading reaching a range of 0.8 mg/cm²-3.2 mg/cm², which is much higher than the effective catalyst loading of most nano-catalysts. When used as a catalyst for hydrogen production by water splitting, the hydrogen evolution overpotential of the surface of the six-membered high-entropy foam after cleaning and activation is within a range of 36 mV-60 mV, and the six-membered high-entropy foam can operate stably at industrial-level current density (500 mA/cm²), which outperforms the performance of ordinary high-entropy alloy strips and films. At the same time, the preparation method does not require harsh environment such as high temperature or high vacuum, making the method simple and easy to implement, with low-cost raw materials.

### BRIEF DESCRIPTION OF THE DRAWINGS

FIG. 1 is a diagram illustrating an energy spectrum of a NiFeCuCoMoPt high-entropy alloy foam according to some embodiments of the present disclosure;

FIG. 2 is a diagram illustrating a low magnification morphological image and a high magnification morphological image of a NiFeCuCoMoPt high-entropy alloy foam captured by a scanning electron microscope according to some embodiments of the present disclosure;

FIG. 3 is a diagram illustrating linear scan of hydrogen evolution reaction on a surface of a NiFeCuCoMoPt high-entropy alloy foam according to some embodiments of the present disclosure;

FIG. 4 is a diagram illustrating a stability test of a NiFeCuCoMoPt high-entropy alloy foam at 500 mA/cm² according to some embodiments of the present disclosure:

FIG. 5 is a flowchart illustrating a preparation method for the NiFeCuCoMoPt high-entropy alloy foam according to some embodiments of the present disclosure.

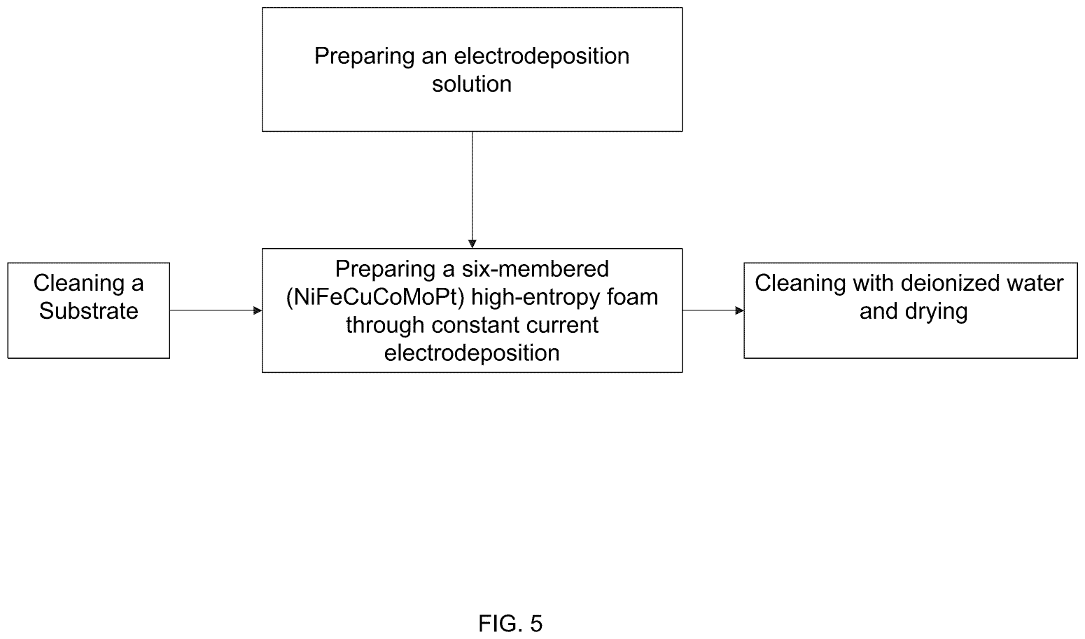

### DETAILED DESCRIPTION

In order to more clearly illustrate the technical solution of the present disclosure, the technical solution of the present disclosure is described in further detail below in conjunction with the accompanying drawings.

According to the present disclosure, a six-membered high-entropy foam for hydrogen production by water splitting comprises: 10 at %-25 at % of Ni, 10 at %-25 at % of Fe, 10 at %-25 at % of Cu, 10 at %-25 at % of Co, 10 at %-25 at % of Mo, and 10 at %-25 at % of Pt.

In some embodiments, the six-membered high-entropy foam has 3D-connected micron-scale pores.

In some embodiments, diameters of the micron-scale pores are within a range of 0.2 um-25 um; and walls of the micron-scale pores are composed of NiFeCuCoMoPt particles packing.

In some embodiments, sizes of the NiFeCuCoMoPt particles are within a range of 100 nm-300 nm.

In some embodiments, catalyst loading of the six-membered high-entropy foam is within a range of 0.8 mg/cm²-3.2 mg/cm², and a hydrogen evolution overpotential of a surface of the six-membered high-entropy foam after cleaning and activation is within a range of 36 mV-60 mV, exhibiting high activity, and the foam maintains a stable overpotential at industrial-level current density (500 mA/cm²), exhibiting high stability.

In some embodiments, a method for preparing the six-membered high-entropy foam for hydrogen production by water splitting, comprising:
operation (1), obtaining a colorless and transparent solution by dissolving complexes (NH₄)₂SO₄, Na₃C₆H₅O₇, and H₃BO₃ in ultrapure water under stirring;
operation (2), obtaining a mixed solution by dissolving metal salts NiSO₄, Fe₂(SO₄)₃, CuSO₄, CoSO₄, Na₂MoO₄, and K₂PtCl₄ in the colorless and transparent solution in sequence under stirring;
operation (3), obtaining a six-membered high-entropy foam by using a Ni sheet as a working electrode and a Pt sheet as a counter electrode, controlling a temperature to 25° C., and performing constant current electrodeposition on the mixed solution;
operation (4), after the constant current electrodeposition is completed, obtaining a washed six-membered high-entropy foam by immersing the six-membered high-entropy foam in the ultrapure water to remove residual impurities on a surface of the six-membered high-entropy foam and washing for three times; and
operation (5), obtaining the six-membered (NiFeCuCoMoPt) high-entropy foam by placing the washed six-membered high-entropy foam in a freeze dryer and freeze-drying for 4 h.

In some embodiments, in operation (1), in the colorless and transparent solution, a concentration of (NH₄)₂SO₄ is within a range of 0.4 M-0.6 M, a concentration of Na₃C₆H₅O₇ is within a range of 0.2 M-0.4 M, and a concentration of H₃BO₃ is within a range of 0.3 M-0.5 M. In some embodiments, in operation (2), in the mixed solution, a concentration of NiSO₄ is within a range of 0.002 M-0.006 M, a concentration of Fe₂(SO₄)₃ is within a range of 0.001 M-0.002 M, a concentration of CuSO₄ is within a range of 0.0002 M-0.0006 M, a concentration of CoSO₄ is within a range of 0.001 M-0.003 M, a concentration of Na₂MoO₄ is within a range of 0.002 M-0.008 M, and a concentration of K₂PtCl₄ is within a range of 0.002 M-0.008 M. After cleaning a deposition substrate, the deposition substrate is placed in the mixed solution for the constant current electrodeposition. The prepared sample is then cleaned with deionized water and dried.

In some embodiments, in operation (3), a current density of the constant current electrodeposition is within a range of 1 A/cm²-4 A/cm², and a deposition time is within a range of 90 s-360 s.

In some embodiments, in operation (4), an immersion time of the six-membered high-entropy foam in the ultrapure water is 15 min.

### Example 1

1) working electrodes were placed in a mixed solution containing NiSO₄, Fe₂(SO₄)₃, CuSO₄, CoSO₄, Na₂MoO₄, K₂PtCl₄, Na₃C₆H₅O₇, H₃BO₃, and (NH₄)₂SO₄;
2) constant current electrochemical deposition was performed;

In step 1), in the mixed solution, a concentration of NiSO₄ was 0.003 M, a concentration of Fe₂(SO₄)₃ was 0.0011 M, a concentration of CuSO₄ was 0.0005 M, a concentration of CoSO₄ was 0.0015 M, a concentration of Na₂MoO₄ was 0.004 M, a concentration of K₂PtCl₄ was 0.004 M, a concentration of (NH₄)₂SO₄ was 0.4 M, a concentration of Na₃C₆H₅O₇ was 0.2 M, and a concentration of H₃BO₃ was 0.3 M.

In step 2), a current density of the constant current electrodeposition was 4 A/cm² and a deposition time was 180 s.

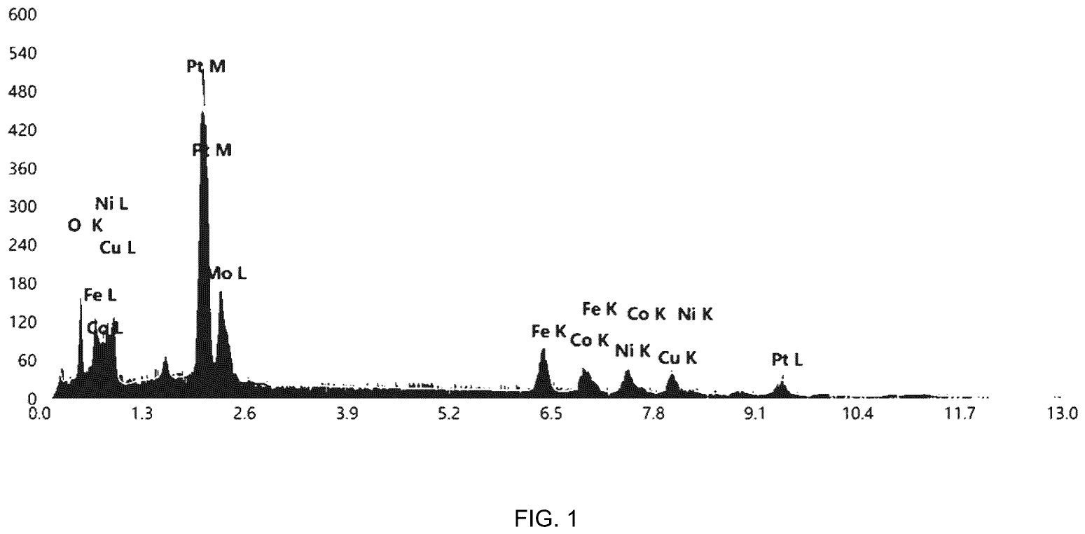

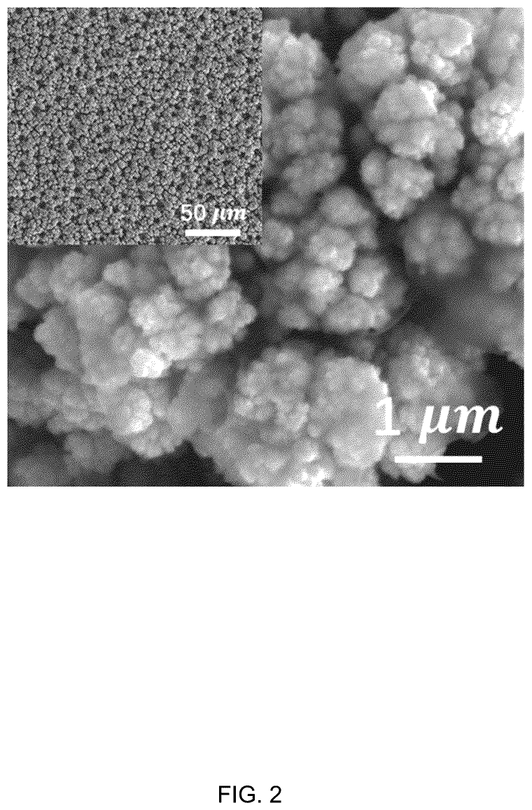

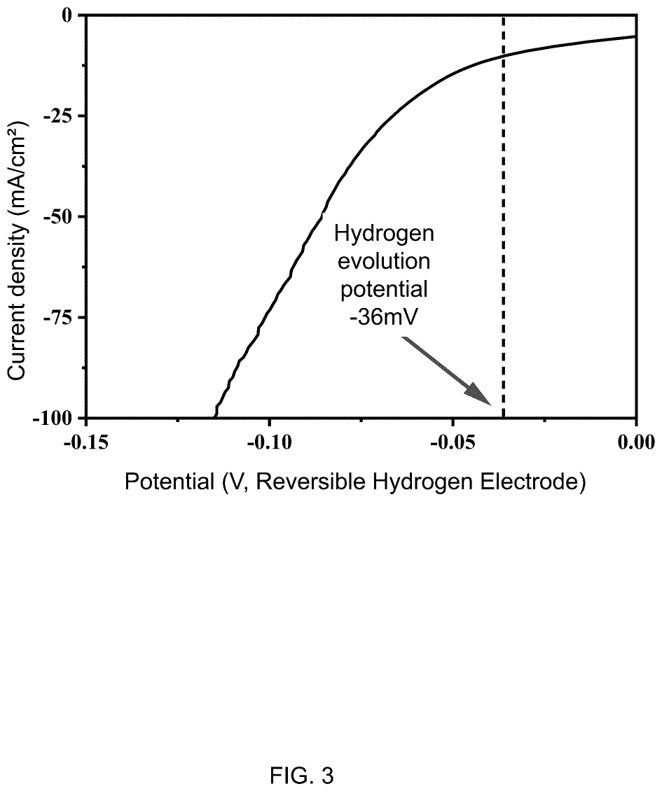

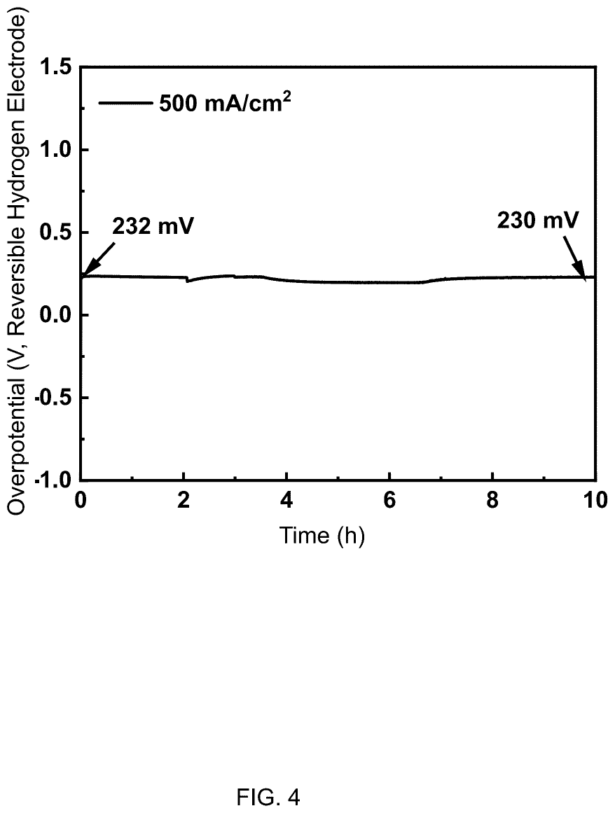

A foam prepared through the above steps consists of Ni, Fe, Cu, Co, Mo and Pt, and according to an energy-dispersive spectrum composition analysis (as shown in FIG. 1), the foam comprises 20 at % of Ni, 20 at % of Fe, 16 at % of Cu, 17 at % of Co, 12 at % of Mo, and 15 at % of Pt. According to observation using a scanning electron microscope (as shown in FIG. 2), the foam has a large number of 3D-connected micron-scale pores whose diameters are within 25 um; walls of the micron-scale pores are composed of NiFeCuCoMoPt particles packing, sizes of the particles are within a range of 100 nm-300 nm. After cleaning and activation, a hydrogen evolution overpotential of a surface of the foam is low as 36 mV, the hydrogen evolution overpotential is taken as a potential applied at a current density of 10 mA/cm² (as shown in FIG. 3). Additionally, a stability test was conducted at industrial-level current density at 500 mA/cm² for 10 h, indicating that a catalytic activity remains unchanged (as shown in FIG. 4).

### Example 2

1) working electrodes were placed in a mixed solution containing NiSO₄, Fe₂(SO₄)₃, CuSO₄, CoSO₄, Na₂MoO₄, K₂PtCl₄, Na₃C₆H₅O₇, H₃BO₃, and (NH₄)₂SO₄;
2) constant current electrodeposition was performed;

In step 1), in the mixed solution, a concentration of NiSO₄ concentration was 0.003 M, a concentration of Fe₂(SO₄)₃ was 0.0011 M, a concentration of CuSO₄ was 0.0005 M, a concentration of CoSO₄ was 0.0015 M, a concentration of Na₂MoO₄ was 0.004 M, a concentration of K₂PtCl₄ was 0.004 M, a concentration of (NH₄)₂SO₄ was 0.4 M, a concentration of Na₃C₆H₅O₇ was 0.2 M, and a concentration of H₃BO₃ was 0.3 M.

In step 2), a current density of the constant current electrodeposition was 2 A/cm² and a deposition time was 180 s.

A foam prepared by the above steps consists of Ni, Fe, Cu, Co, Mo, and Pt, comprising 18 at % of Ni, 16 at % of Fe, 18 at % of Cu, 14 at % of Co, 14 at % of Mo, and 20 at % of Pt; the foam has a large number of 3D-connected micron-scale pores whose diameters are within 10 um; walls of the micron-scale pores are composed of NiFeCuCoMoPt particles packing, and sizes of the particles are within a range of 100 nm-200 nm; catalyst loading of the high-entropy foam is 1.5 mg/cm², and a hydrogen evolution overpotential of a surface of the high-entropy foam after cleaning and activation is low as 50 mV.

### Example 3

1) working electrodes were placed in a mixed solution containing NiSO₄, Fe₂(SO₄)₃, CuSO₄, CoSO₄, Na₂MoO₄, K₂PtCl₄, Na₃C₆H₅O₇, H₃BO₃, and (NH₄)₂SO₄;
2) constant current electrochemical deposition was performed;

In step 1), in the mixed solution, a concentration of NiSO₄ was 0.003 M, a concentration of Fe₂(SO₄)₃ was 0.0011 M, a concentration of CuSO₄ was 0.0005 M, a concentration of CoSO₄ concentration was 0.0015 M, a concentration of Na₂MoO₄ was 0.004 M, a concentration of K₂PtCl₄ was 0.004 M, a concentration of (NH₄)₂SO₄ was 0.4 M, a concentration of Na₃C₆H₅O₇ was 0.2 M, and a concentration of H₃BO₃ was 0.3 M.

In step 2), a current density of the constant current electrodeposition was 1.0 A/cm² and a deposition time was 180 s.

A foam prepared by the above steps consists of Ni, Fe, Cu, Co, Mo, and Pt, comprising 20 at % of Ni, 20 at % of Fe, 19 at % of Cu, 15 at % of Co, 13 at % of Mo, and 13 at % of Pt; the foam has a large number of 3D-connected micron-scale pores whose diameters are within 5 um; walls of the micron-scale pores are composed of NiFeCuCoMoPt particles packing, and sizes of the particles are within a range of 50 nm-100 nm; catalyst loading of the high-entropy foam is 1.1 mg/cm², and a hydrogen evolution overpotential of a surface of the high-entropy foam after cleaning and activation is 54 mV.

### Example 4

1) working electrodes were placed in a mixed solution of NiSO₄, Fe₂(SO₄)₃, CuSO₄, CoSO₄, Na₂MoO₄, K₂PtCl₄, Na₃C₆H₅O₇, H₃BO₃, and (NH₄)₂SO₄;
2) constant current electrodeposition was performed;

In step 1), in the mixed solution: a concentration of NiSO₄ was 0.003 M, a concentration of Fe₂(SO₄)₃ was 0.0011 M, a concentration of CuSO₄ was 0.0005 M, a concentration of CoSO₄ was 0.0015 M, a concentration of Na₂MoO₄ was 0.004 M, a concentration of K₂PtCl₄ was 0.004 M, a concentration of (NH₄)₂SO₄ was 0.4 M, a concentration of Na₃C₆H₅O₇ was 0.2 M, and a concentration of H₃BO₃ was 0.3 M.

In step 2), a current density of the constant current electrodeposition was 2.0 A/cm² and a deposition time was 360 s.

A foam prepared by the above steps consists of Ni, Fe, Cu, Co, Mo, and Pt, comprising 15 at % of Ni, 22 at % of Fe, 18 at % of Cu, 13 at % of Co, 17 at % of Mo, and 15 at % of Pt; the foam has a large number of 3D-connected micron-scale pores whose diameters are within 10 um; walls of the micron-scale pores are composed of NiFeCuCoMoPt particles packing, sizes of the particles are within a range of 100 nm-200 nm; catalyst loading of the high-entropy foam is 3.1 mg/cm², and a hydrogen evolution overpotential of a surface of the high-entropy foam after cleaning and activation is 42 mV.

### Example 5

1) working electrodes were placed in a mixed solution of NiSO₄, Fe₂(SO₄)₃, CuSO₄, CoSO₄, Na₂MoO₄, K₂PtCl₄, Na₃C₆H₅O₇, H₃BO₃, and (NH₄)₂SO₄;
2) constant current electrodeposition was performed;

In step 1), in the mixed solution, a concentration of NiSO₄ was 0.003 M, a concentration of Fe₂(SO₄)₃ was 0.001 M, a concentration of CuSO₄ was 0.0005 M, a concentration of CoSO₄ was 0.0015 M, a concentration of Na₂MoO₄ was 0.004 M, a concentration of K₂PtCl₄ was 0.004 M, a concentration of (NH₄)₂SO₄ was 0.4 M, a concentration of Na₃C₆H₅O₇ was 0.2 M, and a concentration of H₃BO₃ was 0.3 M.

In step 2), a current density of the constant current electrodeposition was 2 A/cm² and a deposition time was 180 s.

A foam prepared by the above steps consists of Ni, Fe, Cu, Co, Mo, and Pt, comprising 24 at % of Ni, 13 at % of Fe, 15 at % of Cu, 15 at % of Co, 17 at % of Mo, and 16 at % of Pt; the foam has a large number of 3D-connected micron-scale pores whose diameters are within 10 um; walls of the micron-scale pores are composed of NiFeCuCoMoPt particles packing, and sizes of the particles are within a range of 100 nm-200 nm; catalyst loading of the high-entropy foam is 1.4 mg/cm², and a hydrogen evolution overpotential of a surface of the high-entropy foam after cleaning and activation is 56 mV.

Finally, it should be understood that the embodiments described herein are used only to illustrate the principles of the embodiments of the present disclosure; other deformations may also fall within the scope of the present invention. Therefore, by way of example, and not as a limitation, alternative configurations of the embodiments of the present disclosure may be considered to be consistent with the teachings of the present disclosure. Accordingly, embodiments of the present disclosure are not limited to those embodiments expressly presented and described herein.

1. A six-membered high-entropy foam for hydrogen production by water splitting, comprising: 10 at %-25 at % of Ni, 10 at %-25 at % of Fe, 10 at %-25 at % of Cu, 10 at %-25 at % of Co, 10 at %-25 at % of Mo, and 10 at %-25 at % of Pt.

2. The six-membered high-entropy foam for hydrogen production by water splitting of claim 1, wherein the six-membered high-entropy foam is filled with 3D-connected micron-scale pores.

3. The six-membered high-entropy foam for hydrogen production by water splitting of claim 2, wherein diameters of the micron-scale pores are within a range of 0.2 um-25 um; and walls of the micron-scale pores are composed of aggregates of NiFeCuCoMoPt particles.

4. The six-membered high-entropy foam for hydrogen production by water splitting of claim 3, wherein sizes of the NiFeCuCoMoPt particles are within a range of 100 nm-300 nm.

5. The six-membered high-entropy foam for hydrogen production by water splitting of claim 1, wherein catalyst loading of the six-membered high-entropy foam is within a range of 0.8 mg/cm²-3.2 mg/cm², and a hydrogen evolution overpotential of a surface of the six-membered high-entropy foam after cleaning and activation is within a range of 36 mV-60 mV.

6. A method for preparing the six-membered high-entropy foam for hydrogen production by water splitting of claim 1, comprising:
operation (1), obtaining a colorless and transparent solution by dissolving complexes (NH₄)₂SO₄, Na₃C₆H₅O₇, and H₃BO₃ in ultrapure water under stirring;
operation (2), obtaining a mixed solution by dissolving metal salts NiSO₄, Fe₂(SO₄)₃, CuSO₄, CoSO₄, Na₂MoO₄, and K₂PtCl₄ in the colorless and transparent solution in sequence under stirring;
operation (3), obtaining a six-membered high-entropy foam by using a Ni sheet as a working electrode and a Pt sheet as a counter electrode, controlling a temperature to 25° C., and performing constant current electrodeposition on the mixed solution;
operation (4), after the constant current electrodeposition is completed, obtaining washed six-membered high-entropy foam by immersing the six-membered high-entropy foam in the ultrapure water to remove residual impurities on a surface of the six-membered high-entropy foam and washing for three times; and
operation (5), obtaining the six-membered (NiFeCuCoMoPt) high-entropy foam by placing the washed six-membered high-entropy foam in a freeze dryer and freeze-drying for 4 h.

7. The method for preparing the six-membered high-entropy foam for hydrogen production by water splitting of claim 6, wherein
in operation (1), in the colorless and transparent solution, a concentration of (NH₄)₂SO₄ is within a range of 0.4 M-0.6 M, a concentration of Na₃C₆H₅O₇ is within a range of 0.2 M-0.4 M, and a concentration of H₃BO₃ is within a range of 0.3 M-0.5 M.

8. The method for preparing the six-membered high-entropy foam for hydrogen production by water splitting of claim 6, wherein
in operation (2), in the mixed solution, a concentration of NiSO₄ is within a range of 0.002 M-0.006 M, a concentration of Fe₂(SO₄)₃ is within a range of 0.001 M-0.002 M, a concentration of CuSO₄ is within a range of 0.0002 M-0.0006 M, a concentration of CoSO₄ is within a range of 0.001 M-0.003 M, a concentration of Na₂MoO₄ is within a range of 0.002 M-0.008 M, and a concentration of K₂PtCl₄ is within a range of 0.002 M-0.008 M.

9. The method for preparing the six-membered high-entropy foam for hydrogen production by water splitting of claim 6, wherein
in operation (3), a current density of the constant current electrodeposition is within a range of 1 A/cm²-4 A/cm², and a deposition time is within a range of 90 s-360 s.

10. The method for preparing the six-membered high-entropy foam for hydrogen production by water splitting of claim 6, wherein
in operation (4), an immersion time of the six-membered high-entropy foam in the ultrapure water is 15 min.
